(19) United States
(12) Patent Application Publication
(10) Pub. No.: US 2002/0006797 A1
(43) Pub. Date: Jan. 17, 2002

(54) Service delivery in a mobile communications system supporting two connection types

(76) Inventors: Kari O. Virtanen, Tampere (FI); Serge Haumont, Helsinki (FI); Asko Haapapuro, Oulu (FI)

Correspondence Address: Michael B. Lasky, Altera Law Group, Suite 100, 6500 City West Parkway, Minneapolis, MN, 55344-7701, US

(21) Appl. No.: 09/860,359

(22) Filed: May 18, 2001

Related U.S. Application Data
(63) Continuation of application No. PCT/FI99/00954, filed on Nov. 17, 1999.

(30) Foreign Application Priority Data
Nov. 19, 1998 (FI) 982504

(51) Int. Cl. H04Q 7/20

(52) U.S. Cl. 455/445; 455/414

(57) ABSTRACT

A method, a system and a mobile station in a system providing services which can be delivered to a user via two different connection types. In order to secure the service delivery, suppression of connection type is used when the connection type does not support the service.

### BACKGROUND OF THE INVENTION

The present invention relates to services which can be delivered to a user via a first connection type or via a second connection type in a mobile communications system.

A mobile communications system refers generally to any telecommunications system which enables wireless communication when users are moving within the service area of the system. A typical mobile communications system is a Public Land Mobile Network (PLMN).

Mobile communications systems have been developed because there has been a need to free users to move away from fixed telephone terminals without impairing availability of users. Simultaneously with -the development of mobile communications systems, various services have also been introduced in mobile communications systems and various new forms of service for the present and future mobile networks are being planned.

An example of an existing mobile communications system is the pan-European mobile communications system GSM (Global System for Mobile Communications). The General Packet Radio Service GPRS is a new service in the GSM system, and it is one of the topics of GSM Phase 2+ standardization work at ETSI (European Telecommunications Standards Institute). The GPRS service allows packet data transfer between mobile data terminals and external data networks, while the “original” GSM network allows circuit-switched communications. If the user is attached to a packet data service and to a circuit-switched service at the same time, he/she is connected to two different kinds of connection types, which are also called routes. The GPRS network architecture is illustrated in FIG. 1.

Some services use either the circuit-switched route or the packet-switched route for the delivery so that the user sees the service as one service irrespective of a connection type used. An example of this kind of a service is the short message service SMS and related services, for example the intelligent network short message service IN-SMS.

The network nodes, such as a mobile service switching centre MSC in a circuit-switched connection and a serving GPRS support node SGSN in a packet-switched connection, do not necessarily provide the same services, or the service is not necessarily available in both nodes at the same time although in principle the delivery of that service does not depend on the connection type used. If the nodes do not support same services, the problem is that the services function or do not function depending on the selected connection type for delivery. For example, mobile-originated barrings are available when the same subscriber tries to send mobile-originating short messages via the MSC, but are not available on the GPRS side. Another problem is that the service launch may be delayed because only the GPRS or the GSM side supports this service.

### BRIEF DESCRIPTION OF THE INVENTION

An object of the invention is to overcome the above problems and assure that the connection type, which does not support the service, is not selected for the delivery of a service.

This and other objects of the invention are achieved with a method, a mobile communications system and a mobile station which are characterized in what is disclosed in the independent claims. The preferred embodiments of the invention are set forth in the dependent claims.

In the invention the sending and/or reception of a service via at least one of two or more parallel connection types is suppressed when the at least one connection type does not support the service (or some feature of the service). Thus, the advantage of the invention is that services can be provided also in cases where the other connection type does not yet support the service as a whole, for example intelligent network short message services can be provisioned to GPRS subscribers although the SGSN does not support them.

In an embodiment of the invention, the information indicating the state of suppression of the first connection type is indicated to the mobile station during the attach procedure. A further advantage of this embodiment is that unnecessary signalling can be avoided when the mobile station is deciding the connection type via which the service is to be delivered. An example where the unnecessary signalling can be avoided are mobile-originating short messages.

In another embodiment of the invention, the indication that the selected connection type is suppressed is sent to the mobile station after the first service request. The further advantage of this embodiment is that the quantity of information transferred over the air interface during the attach procedure is minimized. Furthermore, the indication is sent over the air interface only when it is needed for the first time after the attach procedure. So the indication is not transferred to the mobile station unnecessarily. If the service is not used at all during the time the mobile station is attached, the indication is not needed and unnecessary information transfer is avoided.

In another embodiment of the invention, the indication indicating the state of the suppression is updated in response to a location update. A further advantage of this embodiment is that the first connection type can have different kinds of network nodes and the different capabilities of the nodes can be taken into account when determining if the route should be suppressed or not.

### BRIEF DESCRIPTION OF THE FIGURES

The invention will be described in further detail in the following by means of preferred embodiments with reference to the accompanying drawings, in which

FIG. 1 illustrates the GPRS architecture;

FIGS. 2 to 8 represent signalling charts in various embodiments of the invention; and

FIG. 9 is a flow chart illustrating the function of an MS according to a third preferred embodiment of the invention.

### DETAILED DESCRIPTION OF THE INVENTION

The present invention is suitable for use in mobile communications system where various combinations of different data connection types provide different routes via which the subscriber can obtain the same service. The invention is particularly suitable for use in implementing the General Packet Radio Service (GPRS) in the pan-European digital mobile communications system GSM (Global System for Mobile Communications) or corresponding mobile communications systems, such as DCS1800 and PCS (Personal Communication System). At present, third generation mobile systems, such as the Universal Mobile Communication System (UMTS) and the Future Public Land Mobile Telecommunication System (FPLMTS), later renamed as IMT-2000 (international Mobile Telecommunication 2000), are being developed. They utilize different kinds of core networks which may offer at least two different connection types like the GPRS packet radio network does. Telecommunication networks that are considered to be suitable core networks are second generation mobile communication systems (PSTN), such as GSM, ISDN (Integrated Services Digital Network), B-ISDN (Broadband ISDN), PDN (Packet Data Network), ATM etc. Thus the invention is also suitable for use in these third generation mobile systems.

In the following, the primary -embodiments of the invention will be described by means of a GPRS packet radio network formed by a combination of the GPRS service and the GSM system, yet without limiting the invention to that kind of particular packet radio system.

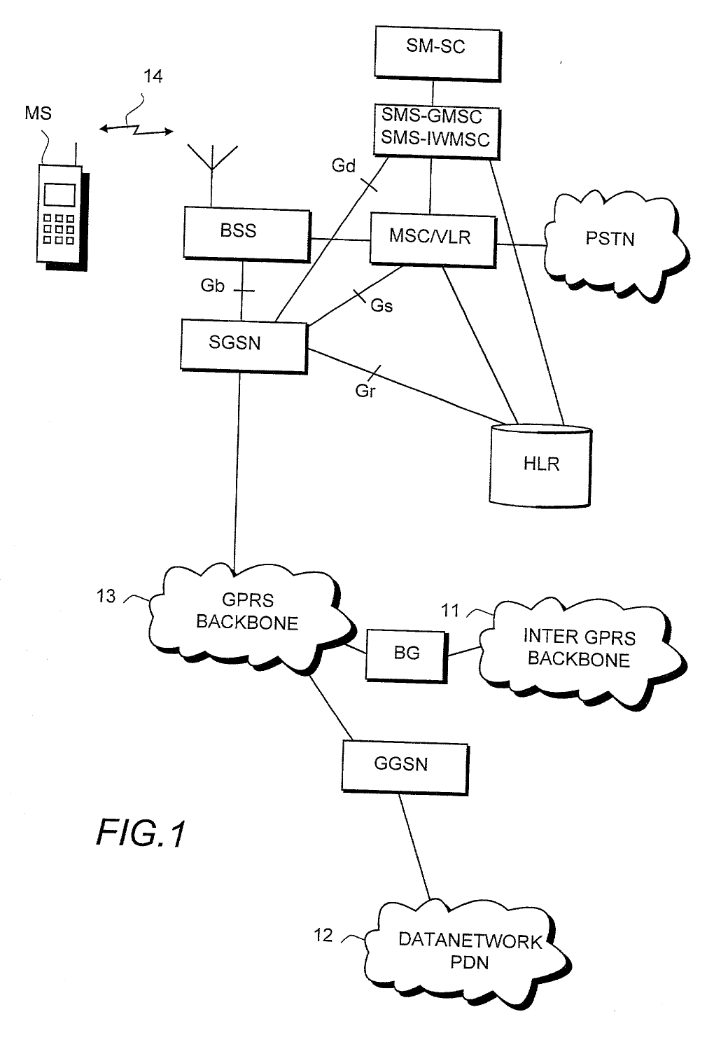

FIG. 1 illustrates a GPRS packet radio service implemented in the GSM system. For a more detailed description of the GPRS, reference is made to ETSI GSM 03.60, version 6.0.0, and the cross-references thereof.

The basic structure of a GSM network is composed of two parts: a base station subsystem BSS and a network subsystem NSS. The base station subsystem BSS and the mobile stations MS communicate over radio links 14. The network subsystem comprises a mobile-services switching centre MSC, a visitor location register VLR and a home location register HLR. The MSC manages the switching of circuit-switched services and carries out functions that are only characteristic of mobile communications, in co-operation with the VLR and the HLR. The VLR stores the subscriber data of an MS temporarily while the MS is in the area of the MSC connected to the VLR if the MS is attached to circuit-switched services. For the short message service SMS, the GSM network has a connection to a short message service centre SM-SC which will be described later. This basic GSM network offers a circuit-switched connection to the SM service via the MSC/VLR to a mobile station attached to the basic GSM network. (Herein, SM refers to a short-message.) This connection is also called a CS route, and the basic GSM network as a CS network. For a more detailed exposition of the GSM system, reference is made to The GSM System for Mobile Communications, M. Mouly and M. Pautet, Palaiseau, France, 1992, ISBN: 2-9507190-07-7. It is to be understood that the CS network may have any number of network elements, such as mobile service switching centres.

In FIG. 1, the GPRS service connected to the GSM network comprises a GPRS subnetwork having a serving GPRS support node SGSN, a border gateway BG and a GPRS gateway support node GGSN. These different support nodes SGSN and GGSN, and the BG are interconnected by an Intra-Operator Backbone Network 13. It is to be understood that the GPRS network may have any number of network elements, such as support nodes, gateway support nodes and border gateways.

The serving GPRS support node SGSN is a node serving a mobile station MS. Each support node SGSN controls a packet data service within the area of one or more cells in a cellular packet radio network, and each support node SGSN is therefore connected (Gb interface) to a certain local element of the GSM system. For this purpose, each support node SGSN is connected (Gb interface) to a specific local part of the GSM mobile communications system. This connection is typically made to the base station subsystem BSS. A mobile station MS in a cell communicates across the radio interface 14 with a base station BTS and further through the mobile communications network with the support node SGSN to whose service area the cell belongs. In principle, the mobile communication network between the support node SGSN and the mobile station MS only relays packets between these two. To implement this, the mobile communication network provides packet-switched transmission of data packets between the mobile station MS and the serving support node SGSN. This forms a packet-switched connection which is also called a GPRS route. The SGSN is also provided with a signalling interface Gs to the VLR and/or to the MSC, e.g. a signalling connection SS7. The SGSN may transmit location information to the MSCNLR and/or receive requests to search for a GPRS subscriber from the MSCNLR. For the short message service, the SGSN network has a connection to a short message service centre SM-SC via SMS-GMSC/IWMSC. This route offers a packet-switched connection to the SM service. This connection is also called the GPRS route. It is to be noted that the mobile communications network only provides a physical connection between the mobile station MS and the support node SGSN, and its precise operation and structure have no essential significance to the invention.

When the mobile station MS becomes attached to the GPRS network, i.e. in connection with a GPRS Attach procedure, the SGSN establishes a mobility management context (MM context) that contains information pertaining to the mobility and security of the mobile station MS. In this context, a mobile station generally refers to a mobile unit or a mobile subscriber.

The border gateway BG connects the GPRS service of the operator to the GPRS services of other operators by providing access to an interoperator GPRS backbone network 11. The GPRS gateway support node GGSN connects the GPRS service to data networks 12, such as an InterOperator Backbone Network, IP network (Internet) or X.25 network. SGSN, BG and/or GGSN functionalities may be combined in the same physical node.

The home location register HLR of the GSM network comprises GPRS subscriber data and routing information, including the International Mobile Subscriber Identity (IMSI). The HLR maintains in its registers a subscription list for each subscriber which contains the provisioned services of the subscriber. The home location register HLR in accordance with the invention may also be adapted to maintain in its registers information on whether a route which could be used for service delivery is suppressed. This can be done for example by using a flag or flags so when the flag is on, the route is suppressed. These flags are maintained preferably in the subscriber information and therefore e.g. the GPRS route for the SM delivery of a subscriber who has provisioned an IN-SMS may be suppressed, but the GPRS route for the SM delivery of a subscriber who has provisioned only a “basic” SMS is not suppressed. The SGSN has a Gr interface to the HLR (direct signalling connection or through an intra-operator backbone network 13). The HLR of a roaming mobile station MS may be in a different mobile communications network than the serving SGSN or the serving MSC/VLR.

A service in mobile communications networks is the short message service SMS. The SMS differs from voice and data services in that no connection from the sending party to the receiving party need to be established, as the short messages are transmitted in the form of signalling messages. Short message services are asymmetric, and the transmission of a mobile-originated short message is considered to be a different service from the transmission of a mobile-terminated short message. In a GSM system, short messages can be received and sent even during an ongoing call, because short messages are relayed on control channels. A short message service centre SM-SC is an entity delivering short messages and storing and retransmitting short messages, the delivery of which has failed. All short messages pass through a short message service centre SM-SC. A short message service centre can receive a short message through any network for delivery to a mobile station MS. The short message service centre SM-SC transfers the short message it received to a gateway mobile switching centre for short message service SMS-GMSC for further delivery to a mobile station. These messages are called MT-SM (Mobile Terminating Short Message). An incoming short message from a mobile station is transmitted via an interworking mobile switching centre for short message service SMS-IWMSC to a short message service centre for further delivery. These message are called MO-SM (Mobile Orinating Short Message). To provide short message service, a GPRS network has a serving GPRS support node SGSN connected to a gateway mobile switching centre for short message service, SMS-GMSC, and to an interworking mobile switching centre for short message service, SMS-IWMSC. Through these, a mobile station MS attached to a GPRS service can send and receive short messages on the radio channels of the GPRS.

In this figure, the short message service (and the corresponding network elements) represents all services which can be delivered to an MS via two different connection types in such a way that the user does not notice the difference. Another service could be USSD (Unstructured Supplementary Service Data), which is one of the mechanisms for implementing new services.

The intra-operator backbone network 13, interconnecting the operator equipment SGSN, GGSN and BG, may be implemented with a local area network, e.g. an IP network. It is to be noted that it is also possible to implement the operator GPRS network without any intra-operator backbone network, e.g. by implementing all features in a single computer.

The present invention can be implemented in existing network elements and mobile stations. They all have processors and memories with which the inventive functionality described below may be implemented.

In the following figures and in their descriptions it is assumed that the service which can use either a CS route or a GPRS route is the SMS, yet without limiting the invention to that kind of particular service. For the sake of clarity, it is also assumed that the subscriber has provisioned this service. The SMS is used as an example, because it represents a service which actually consists of two different services (that is, MO-SM and MT-SM) and which can be delivered via both routes if they both support this service. Furthermore, SMS-related services, which add some features to the basic SMS, are developed. An example of this kind of a service is the IN-SMS.

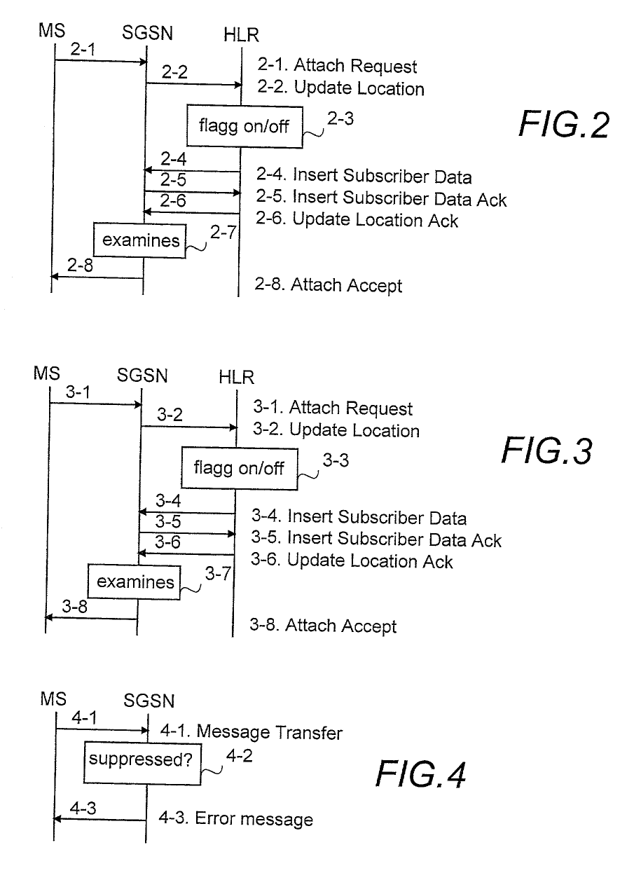

FIG. 2 illustrates signalling in accordance with the invention in a first preferred embodiment. In the first preferred embodiment, MT and MO flags are used in the HLR and suppression is subscriber-specific, that is, the operator sets the values of the flags in the HLR when the SMS is provisioned for that subscriber. The MT flag indicates whether an SM can be delivered via a GPRS route to an MS. Accordingly, the MO flag indicates, whether an MS can send an SM via a GPRS route.

In order to access the GPRS services, an MS shall first make its presence known to the network by performing a GPRS attach. Referring to FIG. 2, the MS initiates the attach procedure by the transmission of a message 2-1 (Attach Request) to the SGSN. Since this is the first attach (or the SGSN number has changed since the detach), the SGSN sends a message 2-2 (Update Location) to the HLR.

In step 2-3 the HLR checks from-its registers the subscriber's provisioned services and the value of the MO flag of the SMS. Then the HLR sends a message 2-4 (Insert Subscriber Data) to the SGSN. If the MO flag was off (i.e. the GPRS route is allowed) and the subscriber has provisioned SMS, the message 2-4 includes information -about this service. If the MO flag was on and the subscriber has provisioned SMS, the message 2-4 does not include information about this service.

After receiving the message 2-4, the SGSN acknowledges it with a message 2-5 (Insert Subscriber Data Ack). The HLR acknowledges the message 2-2 by sending a message 2-6 (Update Location Ack) to the SGSN.

In step 2-7 the SGSN examines the message 2-4 and deduces from it whether the GPRS route from the MS is suppressed. The SGSN creates a mobility management context (MM context). The MM context comprises subscriber data. The SGSN also adds information indicating whether the GPRS route from the MS is suppressed into the MM context. In the first preferred embodiment it is assumed that if the message 2-4 does not include information about the SMS, the GPRS route is suppressed for the MO-SM-delivery. The SGSN sends a message 2-8 (Attach Accept) to the MS. The message 2-8 includes a flag or a parameter which indicates whether the MO-SMS delivery is allowed via the SGSN or not. In the first preferred embodiment, the SGSN sets the flag on in the message 2-8 when the GPRS route is suppressed.

According to the first preferred embodiment, when the MS receives the message 2-8, the MS knows whether it can or cannot deliver a MO-SM via the GPRS during the time it is attached to the GPRS. When the user of the MS wants to send an SM, the MS acts according to one of the following possibilities in the first preferred embodiment:

the MS tries to deliver the SM via the GPRS route, if the GPRS route is not suppressed.

the MS tries to deliver the SM via the CS route, if the GPRS route is suppressed and the MS is attached also to the CS network,

the MS performs a CS attach and tries to deliver the SM via the CS route, if the GPRS route is suppressed and the MS is not attached to the CS network, or

the MS does not try to deliver the SM at all, because the GPRS route is suppressed and the MS is not attached to the CS network.

FIG. 3 illustrates signalling in accordance with the invention in a second preferred embodiment. In the second preferred embodiment, the MT and MO flags are also used in the HLR and the suppression is subscriber-specific. Referring to FIG. 3, the MS initiates the attach procedure by the transmission of a message 3-1 (Attach Request) to the SGSN. Since this is the first attach (or the SGSN number has changed since the detach), the SGSN sends a message 3-2 (Update Location) to the HLR.

In the step 3-3 the HLR checks the subscriber's provisioned services and the value of the MO flag of the SMS. Then the HLR sends a message 3-4 (Insert Subscriber Data) to the SGSN. In the second preferred embodiment of the invention, the message 3-4 includes a parameter which indicates whether or not the GPRS route is suppressed for the SMS. For example, if the MO flag was on (i.e. the GPRS route is not allowed) and the subscriber has provisioned SMS, the message 3-4 may contain both provision information about this service and the parameter indicating that the GPRS route is suppressed.

After receiving the message 3-4, the SGSN acknowledges it with a message 3-5 (Insert Subscriber Data Ack). The HLR acknowledges the message 3-2 by sending a message 3-6 (Update Location Ack) to the SGSN.

In step 3-7 the SGSN examines the message 3-4 and deduces from it whether the GPRS route from the MS is suppressed. The SGSN creates a mobility management context (MM context). The MM context comprises subscriber data. The SGSN also adds information as to whether the GPRS route from mobile is suppressed into the MM context according to the information it received in the message 3-4. The SGSN sends a message 3-8 (Attach Accept) to the MS. The message 3-8 includes a flag or a parameter which indicates whether the MO-SMS delivery is allowed via the SGSN or not. In the second preferred embodiment, the SGSN sets the flag on in the message 3-8 when the GPRS route is suppressed.

In accordance with the second preferred embodiment, when the MS receives the message 3-8, the MS knows whether it can or cannot deliver the MO-SM via the GPRS while it is attached to the GPRS.

In another embodiment of the invention, the message 2-8 or the message 3-8 includes a new parameter “GPRS route allowed for the MO-SM” only when the MO-SM delivery is allowed via the SGSN. If the GPRS route is not suppressed, the SGSN adds this parameter to the message 2-8 or to the message 3-8. If the parameter is in the message 2-8 or in the message 3-8, the MS notices that it can use the GPRS route for delivering the SM. If the parameter is missing, the MS knows that the GPRS route is suppressed.

FIG. 4 illustrates signalling in accordance with the invention in a third preferred embodiment in a situation where e.g. an error has occurred in the MS, or the SMS subscription has been modified by the operator after the MS attached to the network, and the MS does not know that the GPRS route is suppressed, although the MS should known this according to any one of the above embodiments. For this- reason the MS still tries to send an SM via the GPRS route by transferring it to the SGSN in a message 4-1 (Message Transfer). In step 4-2 the SGSN checks the MS subscription data in the MM context and notices that the GPRS route for the MO-SM is suppressed. Instead of transferring the SM, the SGSN sends a message 4-3 (Error message) to the MS. The message 4-3 includes a route error code indicating that, although the facility is subscribed, the selected route is not allowed. After receiving this route error code, the MS no longer tries to send an MS via the GPRS route until it performs a new GPRS attach.

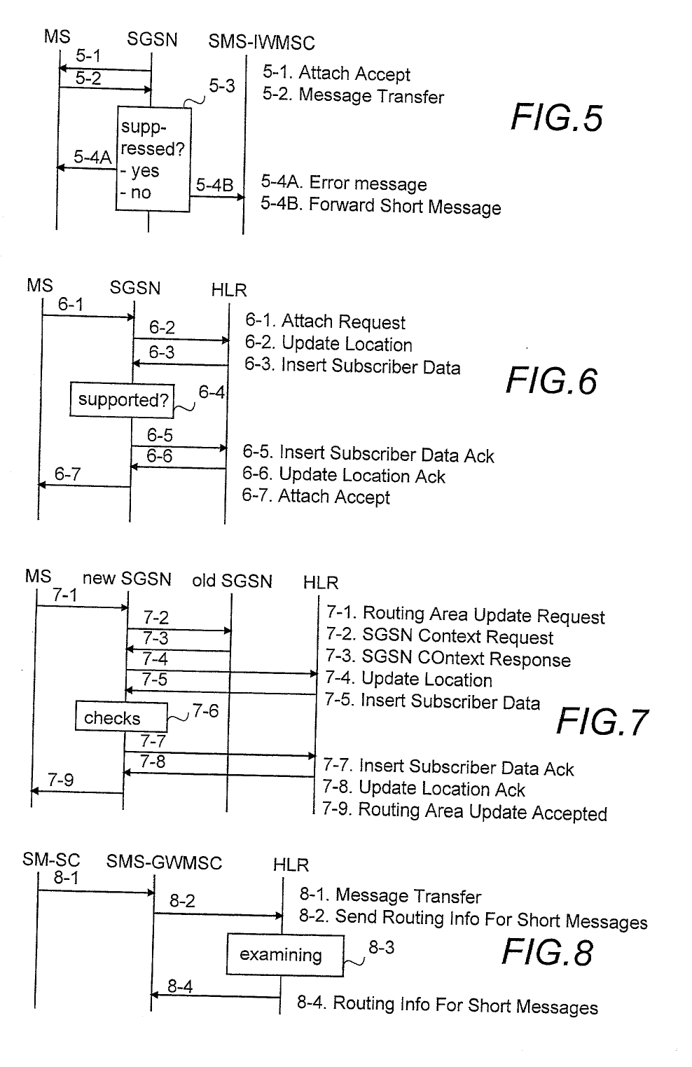

FIG. 5 illustrates signalling in accordance with the invention in a fourth preferred embodiment. Also in the fourth preferred embodiment the MT and MO flags are used in the HLR and the suppression is subscriber-specific. FIG. 5 illustrates signalling starting from a situation where the SGSN already knows whether or not the GPRS route is suppressed. The SGSN knows this according to the first or second embodiment from the HLR. (the figure consequently starts after step 2-7 or 3-7). Referring to FIG. 5, the SGSN sends a message 5-1 (Attach Accept) to the MS. The message 5-1 differs from previously described corresponding messages in that it does not include any indication of whether or not the GPRS route is suppressed for the MO-SM delivery.

The MS has a first SM to send after the attach procedure. Since in the fourth preferred embodiment the MS has no knowledge of whether or not the GPRS route is suppressed, the MS transfers the SM to the SGSN in a message 5-2 (Message Transfer). In step 5-3 the SGSN checks the MS subscription data in the MM context and notices that the GPRS route for the MOSM is suppressed.

If the GPRS route is suppressed, the SGSN sends a message 5-4A (Error message) to the MS instead of transferring the SM. The message 5-4A includes a route error code indicating that although the facility is subscribed, the selected route is not allowed. When the MS receives the message 5-4A, the MS-knows, all the time it is attached to the GPRS, that it cannot deliver the MO-SM via the GPRS in the fourth preferred embodiment. In other words, the MS does not attempt to send an SM through the GPRS route after receiving said route error code. And if it will try, it will not succeed. Instead it will get the error message 5-4A. If the MS is also attached to the CS side, the MS will automatically try that route after receiving the message 5-4A.

If the GPRS route is not suppressed, the SGSN forwards the SM to the SMS-IWMSC in a message 5-4B (Forward Short Message).

Because the actual delivery of the SM is not relevant to the present invention, it will not be described herein.

FIG. 6 illustrates signalling in accordance with the invention in a fifth preferred embodiment. In the fifth preferred embodiment, the suppression is SGSN-specific, that is, the suppression depends on the properties of that SGSN which is serving an MS. Referring to FIG. 6, the MS initiates the attach procedure by the transmission of a message 6-1 (Attach Request) to the SGSN. Since this is the first attach (or the SGSN number has changed since the detach) the SGSN sends a message 6-2 (Update Location) to the HLR. The HLR responds by sending a message 6-3 (Insert Subscriber Data) to the SGSN.

In step 6-4 the SGSN checks the subscriber's provisioned services and whether it supports those services. It can check all services or only some of them. For example, it can check if the SMS was included in the message 6-3 and if this service is supported in the SGSN. During this check the SGSN also creates a mobility management context (MM context). In the fifth preferred embodiment, the MM context also comprises a flag indicating whether or not the GPRS route from mobile is suppressed. The flag is on if the SGSN does not support the SMS and off if the SGSN supports the SMS. In other words, if the flag is on, the GPRS route is suppressed.

After finishing step 6-4, the SGSN acknowledges the message 6-3 with a message 6-5 (Insert Subscriber Data Ack). In the fifth preferred embodiment, when the GPRS route is suppressed, this message includes information indicating the route suppression to the HLR. With this information the HLR may set in its registers the flag “MT-SM not via GPRS” on if desired by the operator. In some other embodiments, the message 6-5 includes no information about route suppression. The HLR acknowledges the message 6-2 by sending a message 6-6 (Update Location Ack) to the SGSN.

Then the SGSN sends a message 6-7 (Attach Accept) to the MS. In the fifth preferred embodiment, the message 6-7 indicates whether or not the GPRS route is suppressed (the message 2-8 described in FIG. 2). After receiving the message 6-7, the MS knows, when attached to the GPRS, whether it can or cannot deliver the MO-SM via the GPRS in the fifth preferred embodiment. In some other embodiments the message 6-7 (Attach Accept) may correspond to the message 5-1 described in FIG. 5.

FIG. 7 illustrates a situation where the MS makes an inter-SGSN Routing Area Update in the fifth embodiment by sending a message 7-1 (Routing Area Update Request) to the new SGSN. The new SGSN sends a message 7-2 (SGSN Context Request) to the old SGSN, which responds by sending a message 7-3 (SGSN Context Response) to the new SGSN. The message 7-3 comprises the MM context of the MS in the old SGSN, for example. The new SGSN then sends a message 7-4 (Update Location) to the HLR. The HLR responds by sending a message 7-5 (Insert Subscriber Data) to the new SGSN.

In step 7-6 the new SGSN checks the subscriber's provisioned services and whether it supports those services. In the fifth embodiment the new SGSN also checks from the information obtained in the message 7-3 whether the old SGSN supported those services. It can check all services or only some of them. For example, it may check if the SMS was included in the message 7-5, if the SMS was supported in the new SGSN and if the GPRS route for SMs was suppressed in the old SGSN. During this checking the new SGSN also creates a mobility management context (MM context).

After finishing the step 7-6, the SGSN acknowledges the message 7-5 with a message 7-7 (Insert Subscriber Data Ack). In the fifth preferred embodiment, if the new SGSN supports same services as the old SGSN (i.e. the state of route suppression has not changed), the message 7-7 does not contain any information about route suppression. If the services supported by the new SGSN and the old SGSN differs for example in that the route has to be suppressed in the new SGSN, but the GPRS route was not suppressed in the old SGSN, the message 7-7 indicates this change. If the message indicates a change in route suppression, the HLR updates its registers by changing the information, for example by setting in its registers the flag “MT-SM not via GPRS” off (if it were on). In those embodiments where the message 6-5 includes no information about route suppression, the message 7-7 naturally does not include any indication about a change in route suppression. The HLR acknowledges the message 7-7 by sending a message 7-8 (Update Location Ack) to the SGSN.

Then the SGSN sends a message 7-9 (Routing Area Update Accepted) to the MS. In the fifth embodiment of the invention, the message may contain an indication of route suppression change in the same way as was described earlier with the message 7-7. If the message 7-7 indicates a change in route suppression, the MS updates it files. Otherwise they remain unchanged.

In yet other embodiment of the invention, the messages 7-7 and 7-9 always contain the same information about possible route suppression of the SMS as the messages 6-5 and 6-7, because the new SGSN does not compare services it supports with services the old SGSN supported.

In yet another embodiment of the invention, the SGSN indicates to the MS if the GPRS route is suppressed or not with every location update accept and/or routing area update accept message, even if it is an intra-SGSN update. The HLR can update the subscriber information in the SGSN when e.g. the subscriber's subscription information is changed in the HLR. When the MM context is updated in the SGSN, the SGSN may indicate the state of the GPRS suppression to the MS in an update message. In yet another embodiment of the invention, the SGSN sends the update message containing indication of the suppression of the GPRS route only when the state of the suppression has been changed during MM context updating.

FIG. 8 illustrates signalling in accordance with the invention in all the above preferred embodiments, where also the MT flag is used in the HLR. It also illustrates the signalling in an embodiment where only the MT flag is used.

Referring to FIG. 8, the SM-SC has an SM to be sent to an MS. The SM-SC forwards the SM to an SMS-GMSC in a message 8-1 (Message Transfer). The SMS-GMSC examines the destination MS Address and sends a message 8-2 (Send Routing Info For Short Messages) to the relevant HLR in order to know where to route the SM. In step 8-3 the HLR examines its registers and finds out whether or not the “GPRS route suppressed for the MT” flag is on. The HLR then returns a message 8-4 (Routing Info For Short Messages) to the SMS-GMSC. If the flag was on (i.e. the GPRS route is suppressed), the message 8-4 contains only the MSC number. If the flag was off, the message 8-4 also contains the SGSN number. The SMS-GMSC continues the message delivery procedures to the MS according to known solutions in both cases. Because the actual delivery of the SM is not relevant to the present invention, it will not be described herein. By giving only the MSC number when the GPRS route is suppressed, unnecessary signalling is avoided, because the SMS-GMSC does not try to deliver the SM via the GPRS route, which does not support the SM delivery.

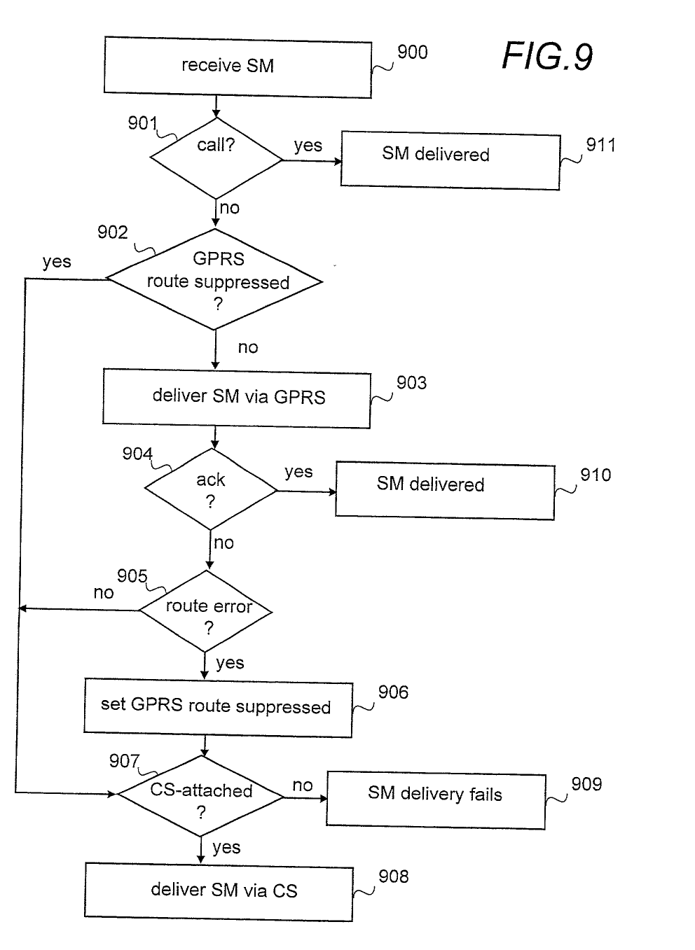

FIG. 9 is a block diagram illustrating the function of the MS in the third preferred embodiment. In FIG. 9, it is assumed that the SM delivery will be successful if the selected route is available. In step 900 the MS receives an order to send an SM from the user of the MS. In step 901 the MS checks if there is an ongoing call. If there is no ongoing call, the MS checks in step 902 if the GPRS route is suppressed. If the route is not suppressed (as is the case at least in the third embodiment if the SM is the first SM after the GPRS attach procedure), the MS delivers the SM via the GPRS route in step 903. The MS receives an acknowledgement and checks in step 904 if the acknowledgement was an ack indicating that the delivery was successful. If it was not an ack, the MS has received an error code. The MS checks in step 905 whether the error code was a route error code. If it was a route error code, the MS sets in step 906 the GPRS route to suppressed. The MS then checks in step 907 if it is also CS attached. If it is, it delivers the SM via the CS route in step 908. If it is not CS attached (or the MS cannot at the same time be CS and GPRS attached), the SM delivery fails (step 909).

If the error code was not a route error code (step 905), the MS goes directly to step 907.

If the acknowledgement was an ack, the GPRS route was not suppressed and the SM was delivered (step 910).

If in step 902 the MS finds out that the GPRS route is suppressed (as it may be if the SM is for example a second one after the attach procedure in third preferred embodiment), it will go to step 907 to check whether it is also CS attached. After that it will continue as described.

If, in step 901, the MS finds out that a call is going on, it delivers in step 911 the SM via control channels related to that call.

In some other embodiments some steps may be missing, for example in the first and second embodiments steps 905 and 906 are not needed and step 907 comes right after step 904.

In yet another embodiment of the invention, the mobile station is arranged to carry out in step 909 the following substeps (or at least first two of them):

performs a CS attach (CS attach procedure),

delivers an SM via a CS route, and

preferably performs a CS detach (CS detach procedure).

If the mobile station cannot be attached to-both routes simultaneously, the CS attach procedure includes GPRS detach procedure and the CS detach procedure includes also GPRS attach procedure. If the mobile station can be attached to both routes simultaneously, the above CS procedures may include the above GPRS procedures.

The steps and messages have not been set out in absolute time sequence in FIGS. 2 to 9. Some of the above steps and messages may take place simultaneously or in a different order, for example step 2-5 and messages 2-6 and 2-7 in FIG. 2. The messages may include more information than what was stated above. The names of the signalling messages may differ from those set out above or the parameters/flags according to the invention may be sent in other signalling messages than stated above. Also other messages not shown in the figures may be sent between the above messages.

The invention was described above assuming that the HLR has in its registers flags which indicate if the GPRS route is suppressed or not. The value of these flags can be set during location updating or the operator can set them. Alternatively the HLR may dynamically determine the need for suppression on the basis of the current location of the subscriber (i.e. the serving SGSN) and/or based on the current service combination of the MS, e.g. the operator may define a list of services that cause SMS suppression (e.g. MO-IN-SMS could be one such service) with which the GPRS route is suppressed for MO-SM or for MT-SM delivery. This way the operator does not need to determine explicitly for each subscriber whether the GPRS route is suppressed or not. Instead, the HLR determines this dynamically when executing relevant transactions. E.g. in Update GPRS Location operation, the HLR checks the list and compares that with the subscriber data. This dynamic determination can be carried out when the location of the MS is updated, when the subscriber data is updated in the HLR and/or when the routing information for the SM delivery is requested. This determination may be based on the data the HLR has in its register, for example addresses of SGSNs which do not support SMS.

In the above it is also assumed that the HLR has two kinds of flags, one for mobile-originating service (MO-SM) and the other for mobile-terminating service (MT-SM). It is also possible that only one of these flags is used. The values of these flags may be independent from and differ from each other. For example the MO SM flag can be on and the MT SM flag off. It is also possible to use only one flag for both purposes.

In the above embodiments, when a default value is used for the GPRS suppression, the default value is assumed to be “the GPRS route is suppressed”. Alternatively the default value can be “the GPRS route is not suppressed”.

For the sake of clarity, the invention was described above assuming that only the GPRS route is suppressed. However, the CS route can also be suppressed. In other words, the GPRS route to a mobile station, the GPRS route from a mobile station, the CS route to a mobile station, the CS route from a mobile station or any combination of the above routes can be suppressed. In future there may be mobile communication system, where more than two different communication routes may be used to deliver a service to a user. In these systems the invention can be used to suppress one or more routes when needed.

The accompanying drawings and the description pertaining to them are only intended to illustrate the present invention. Different variations and modifications to the invention will be apparent to those skilled in the art, without departing from the scope and spirit of the invention defined in the appended claims.

1. A method for providing a service to a mobile station (MS) in a mobile communications system supporting at least connections of a first type and a second type, where the mobile station (MS) may be attached to either connection type or simultaneously to both connection types,
characterized by the method comprising the steps of:
maintaining in the system an indication indicating whether the first connection type is suppressed for the service, and
indicating the state of suppression of the first connection type at least to an element in the system determining via which of said connection types the service is to be delivered, and
providing the service via the first connection type only if the first connection type is not suppressed.

2. A method as claimed in claim 1, characterized by
checking, in response to suppression of the first connection type, if the mobile station is attached to the second connection type, and
providing the service via the second connection type if the mobile station is attached to the second connection type.

3. A method as claimed in claim 1 or 2, characterized by indicating said state of suppression during the attach procedure of the first connection type.

4. A method as claimed in claim 1, 2 or 3, characterized by indicating said state of suppression by sending the subscription data of said service for the first connection type when the first connection type is not suppressed and by not sending the subscription data of said service for the first connection type when the first connection type is suppressed.

5. A method as claimed in any one of the preceding claims, characterized by indicating said state of suppression to the mobile station during said attach procedure.

6. A method as claimed in any one of the preceding claims, characterized by
receiving a request for the service via a first connection type from the mobile station in said element,
checking said state of suppression, and
indicating the state of suppression to the mobile station if suppression is on, or
providing the service via first connection type if suppression is off.

7. A method as claimed in any one of the preceding claims, characterized by updating said indication in response to location updating of the mobile station.

8. A mobile communications system, comprising
at least a first type and a second type of connection,
at least one mobile station (MS) that can be attached to either connection type or simultaneously to both connection types,
at least one first node (SGSN) for delivery of a service via the first connection type to the mobile stations,
at least one second node (MSC/VLR) for delivery of the service via the second connection type to the mobile stations,
at least one node (HLR) for storing information on which connection types the mobile station is attached to,
characterized in that
at least one of said nodes is arranged to maintain an indication indicating whether the first connection type is suppressed for the service, and
the system is arranged to provide the service via a first connection type only if the first connection type is not suppressed.

9. A system as claimed in claim 8, characterized in that
the system is arranged to provide the service via a second connection type in response to the suppressed first connection type if the mobile station is attached to the second connection type.

10. A system as claimed in claim 8 or 9, characterized in that said node (HLR, SGSN, MSC) maintaining the indication is arranged to indicate the state of the suppression of the first connection type to the mobile station (MS) during the attach procedure to the first connection type.

11. A system as claimed in claim 8, 9 or 10, characterized in that said node (HLR, SGSN, MSC) maintaining the indication is arranged to indicate the state of suppression of the first connection type to the mobile station as a response to a request of the service via the first connection type.

12. A system as claimed in claim 8, 9, 10 or 11, characterized in that in response to the suppression of said first connection type, the mobile station is arranged not to request service via the first connection type.

13. A system as claimed in claim 8, 9, 10, 11 or 12, characterized in that said node (HLR, SGSN, MSC) maintaining the indication is arranged to update the state of suppression of the first connection type as a response to a location update of a mobile station.

14. A system as claimed in claim 8, 9, 10, 11 or 12, characterized in that the indication maintained is updated by a system operator.

15. A system as claimed in claim 13 or 14, characterized in that said node (HLR, SGSN, MSC) maintaining the indication is also arranged to update the state of suppression of the first connection type to the mobile station.

16. A mobile station (MS) in a mobile communications system supporting at least connections of a first type and a second type, where the mobile station can be attached to either connection type or simultaneously to both connection types,
characterized in that
the mobile station (MS) is arranged to derive from the attach procedure an indication whether the first connection type is suppressed for a service and in response to suppression of said first connection type not to request said service via first connection type.

17. A mobile station (MS) in a mobile communications system supporting at least connections of a first type and a second type, where the mobile station can be attached to either connection type or simultaneously to both connection types,
characterized in that
the mobile station (MS) is arranged to derive from an error message it received as a response to a service request an indication whether the first connection type is suppressed and in response to suppression of said first connection type not to request said service via the first connection type.
